(19) United States
(12) Patent Application Publication
(10) Pub. No.: US 2010/0067955 A1
(43) Pub. Date: Mar. 18, 2010

(54) SCANNING OPTICAL APPARATUS AND IMAGE FORMING APPARATUS USING THE SAME

(75) Inventor: Yuuta Naito, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/557,431

(22) Filed: Sep. 10, 2009

(30) Foreign Application Priority Data
Sep. 12, 2008 (JP) 2008-234849

(51) Int. Cl. G03G 15/04

(52) U.S. Cl. 399/221

(57) ABSTRACT

Provided is a scanning optical apparatus capable of forming a high quality image while manufacture of an imaging optical system is facilitated, a length of the apparatus in a direction of height is reduced, and unevenness of illuminance distribution (light amount distribution) on a scanned surface is reduced. The scanning optical apparatus includes a single deflecting unit which deflects respective light beams from multiple light source units toward multiple scanned surfaces by different deflection surfaces, multiple incident optical systems each disposed in each light source unit, multiple optical systems which image the respective light beams on the multiple scanned surfaces, and multiple optical path changing units disposed in the respective optical paths between the single deflecting unit and the multiple scanned surfaces. A thin-film characteristic of each of the optical path changing units is different between the respective optical paths.

### BACKGROUND OF THE INVENTION

1. Field of the Invention

The present invention relates to an optical scanning apparatus and an image forming apparatus using the same. The present invention is suitable for an image forming apparatus such as a laser beam printer, a digital copying machine, or a multifunction printer, which adopts an electrophotography process.

2. Description of the Related Art

Up to now, a scanning optical apparatus is used for an image forming apparatus such as a laser beam printer (LBP), a digital copying machine, or a multifunction printer. In the scanning optical apparatus, a light beam (laser beam) optically modulated and output from a light source unit according to an image signal is periodically deflected by a deflector (an optical deflector) configured by, for example, a rotary polygon mirror.

The deflected light beam is focused on a photosensitive recording medium (photosensitive drum) surface in the form of a spot by means of an imaging optical system (scanning lens system) having an fΘ characteristic, and the surface (surface to be scanned) is optically scanned to record an image.

Further, for the purpose of adjusting timing at which image formation on the photosensitive drum by means of the light beam starts, a deflected light beam directed to an optical scanning start position of the photosensitive drum is detected by a synchronization detecting unit in advance to obtain a synchronization signal for starting optical scanning.

In recent years, an imaging lens configuring the imaging optical system is formed of an easily manufactured plastic lens, and improved in performance.

In the scanning optical apparatus configured by the plastic lens as described above, it is generally difficult to provide a surface of the imaging lens with antireflection coat. For that reason, Fresnel reflection on the surface of the imaging lens is changed by a scanning angle, resulting in a tendency that unevenness of light amount distribution (image plane illuminance unevenness) occurs on the scanned surface.

In order to solve the above-mentioned problem, there has been known a scanning optical apparatus in which reflectance of a mirror is set such that the reflectance in the vicinity of an optical axis and the reflectance out of the optical axis are different from each other in an imaging optical system to correct the unevenness of light amount distribution on a scanned surface (refer to Japanese Patent Application Laid-Open No. H02-035413).

Further, in order to downsize the entire apparatus, there have been proposed various scanning optical apparatuses (opposing scanning optical systems) configured in such a manner that a light beam is input to each of two different deflection surfaces of one deflector, and multiple scanned surfaces are optically scanned by deflecting and scanning multiple light beams at the same time (refer to Japanese Patent Application Laid-Open No. 2004-279581).

FIG. 13 is a schematic diagram illustrating the main portion of the scanning optical apparatus disclosed in Japanese Patent Application Laid-Open No. 2004-279581. In the scanning optical apparatus, the number of optical deflectors each required for one light beam is halved in the entire apparatus to downsize the entire apparatus.

Further, in the apparatus disclosed in Japanese Patent Application Laid-Open No. 2004-279581, a light beam (indicated by an on-axis light beam L) deflected and scanned by a deflector 65 (a polygon mirror rotating about a rotation axis 65c) are guided to scanned surfaces 68a, 68b, 68c, and 68d through a scanning lens 75 and multiple mirrors 76, respectively. Further, the apparatus is configured such that, in terms of an optical path, the on-axis light beam guided to the scanned surface after having been reflected by a mirror closest to the scanned surface is nonparallel to a rotation axis of the deflector.

With the above-mentioned configuration, the optical path is turned back with the aid of the mirrors, and the light beam is guided to the scanned surface at an angle with the rotation axis of the deflector, thereby facilitating a further reduction in sizes of the scanning optical apparatus.

Further, in Japanese Patent Application Laid-Open No. 2004-279581, such a thin film characteristic as to cancel the unevenness of light amount distribution attributable to a reflection surface of the deflector with the mirrors is applied to the mirrors to reduce the unevenness of light amount distribution on the scanned surface.

When the scanning lens (imaging lens) configuring the imaging optical system that converges the light beam deflected by the deflector on the scanned surface is formed of a plastic lens, the configuration of the entire apparatus is facilitated. Further, when the scanning lens is formed in an aspherical shape, the manufacture is facilitated.

However, a large amount of reflected light occurs from the lens surface because it is difficult to coat the lens surface of the plastic lens with an antireflection film.

In this situation, the illuminance distribution on the scanned surface becomes uneven by the surface reflection. That is, the unevenness of illuminance (unevenness of light amount distribution) occurs in a large amount.

Further, when two or more mirrors are employed in an optical path of the imaging optical system, turn-back of the optical path is facilitated to downsize the entire apparatus. In particular, it is easy to reduce a length of the apparatus in the direction of height (a direction of the rotation axis of the deflector).

However, the mirror has a reflection angle characteristic, and therefore the illuminance distribution on the scanned surface becomes uneven.

When the illuminance distribution on the scanned surface is uneven (when there is unevenness of light amount distribution), an image quality in forming an image is largely deteriorated.

### SUMMARY OF THE INVENTION

The present invention aims at providing a scanning optical apparatus which is capable of forming a high quality image while manufacture of an imaging optical system is facilitated, a length of the apparatus in a direction of height is reduced, and unevenness of illuminance distribution (light amount distribution) on a surface to be scanned is reduced, and an image forming apparatus using the scanning optical apparatus.

In order to solve the above-mentioned problems, according to an aspect of the present invention, there is provided a scanning optical apparatus including; a plurality of light source units, a deflecting unit which deflects and scans a plurality of light beams emitted from the plurality of light source units by different deflection surfaces of the deflecting unit, an imaging optical system which is disposed corresponding to the plurality of light beams deflected and scanned by the different deflection surfaces of the deflecting unit, and images the plurality of light beams deflected and scanned by the different deflection surfaces of the deflecting unit on different surfaces to be scanned, and the same number of mirrors which are disposed in each of plurality of optical paths between the deflecting unit and the different surfaces to be scanned, the mirrors disposed in each optical path including a mirror different in incident angle of an on-axis light beam in a sub-scanning section between the mirrors which are disposed in the respective optical paths in the same order from the deflecting unit, in which a reflectance of the on-axis light beam is same between the mirrors different in incident angle of the on-axis light beam, which are disposed in the respective optical paths in the same order from the deflecting unit, and in which the incident angle of the on-axis light beam is defined as an angle formed by a normal line to the mirror and a principal ray of a light beam input to the mirror in the sub-scanning section.

In the above-mentioned scanning optical apparatus, a plurality of the mirrors are disposed in each of the plural optical paths between the deflecting unit and the different surfaces to be scanned, and, of the plurality of the mirrors disposed in each of the plural optical paths, a mirror at a maximum incident angle of the on-axis light beam may be a mirror different in reflectance with respect to the incident angle of the on-axis light beam.

In this case, the mirror at the maximum incident angle of the on-axis light beam may be at an incident angle of 45 degrees or more in the sub-scanning section.

Alternatively, the plural optical paths between the deflecting unit and the different surfaces to be scanned cross each other in the sub-scanning section, and the mirror different in characteristic with respect to the incident angle of the on-axis light beam may be optically disposed at a position closest to one of the different surfaces to be scanned.

Further, in the above-mentioned scanning optical apparatus, the different surfaces to be scanned include two scanned surfaces, the plurality of the mirrors disposed in each of two optical paths between the deflecting unit and the two surfaces to be scanned include two mirrors, of the two mirrors, in a direction along which each of the plurality of light beams travels from the deflecting unit toward each of the two surfaces to be scanned, a mirror first changing one of the two optical paths is defined as a first mirror, and a mirror second changing the one of the two optical paths is defined as a second mirror, and when incident angles of the on-axis light beams on the respective first mirrors in the two optical paths in the sub-scanning section are Θ1a(°) and Θ1b(°), and incident angles of the on-axis light beams on the respective second mirrors in the two optical paths in the sub-scanning section are Θ2a(°) and Θ2b(°), the following conditions may be satisfied:

5(°)≦Θ1a(°)≦20(°);

5(°)≦Θ1b(°)≦20(°);

45(°)<|Θ2b(°)−Θ1b(°)|≦75(°); and

15(°)<|Θ2a(°)−Θ1a(°)|≦45(°).

Alternatively, of the plural optical paths between the deflecting unit and the different surfaces to be scanned, an optical path having a smallest incident angle when the on-axis light beam is input to the mirror at the maximum incident angle of the on-axis light beam may be an optical path optically emitted onto one of the different surfaces to be scanned, which forms a color image having a lowest brightness among color images formed by the multiple optical paths, respectively.

Further, in order to solve the above-mentioned problems, according to another aspect of the present invention, there is provided an image forming apparatus including; the above-mentioned scanning optical apparatus, an image bearing member disposed on each of the different surfaces to be scanned, a developing unit which develops an electrostatic latent image formed on the image bearing member by a light beam scanned by the scanning optical apparatus as a toner image, a transferring unit which transfers the developed toner image to a transferred material, and a fixing unit which fixes the transferred toner image to the transferred material.

The above-mentioned image forming apparatus may further include a printer controller which converts code data input from an external device into image data, and inputs the image data to the scanning optical apparatus.

Further, in order to solve the above-mentioned problems, according to still another aspect of the present invention, there is provided a scanning optical apparatus including; a plurality of light source units, a deflecting unit which deflects and scans a plurality of light beams emitted from the plurality of light source units by different deflection surfaces of the deflecting unit, an imaging optical system which is disposed corresponding to the plurality of light beams deflected and scanned by the different deflection surfaces of the deflecting unit, and images the plurality of light beams deflected and scanned by the different deflection surfaces of the deflecting unit on different surfaces to be scanned, and the same number of mirrors which are disposed in each of plural optical paths between the deflecting unit and the different surfaces to be scanned, the mirrors disposed in each optical path including a mirror different in incident angle of an on-axis light beam in a sub-scanning section between mirrors which are disposed in the respective optical paths in the same order from the deflecting unit, in which a reflectance characteristic with respect to the incident angle from on-axis to off-axis is different between the mirrors different in incident angle of the on-axis light beam, which are disposed in the respective optical paths in the same order from the deflecting unit, and in which the incident angle of the on-axis light beam is defined as an angle formed by a normal line to the mirror and a principal ray of a light beam input to the mirror in the sub-scanning section.

In the above-mentioned scanning optical apparatus, a plurality of the mirrors may be disposed in each of the plural optical paths between the deflecting unit and the different scanned surfaces, and, of the plurality of the mirrors disposed in each of the plural optical paths, a mirror at a maximum incident angle of the on-axis light beam may be a mirror different in reflectance characteristic with respect to the incident angle of the on-axis light beam.

Further, in the above-mentioned scanning optical apparatus, the mirror at the maximum incident angle of the on-axis light beam may be at an incident angle of 45 degrees or more in the sub-scanning section.

Alternatively, the plural optical paths between the deflecting unit and the different surfaces to be scanned cross each other in the sub-scanning section, and the mirror different in reflectance characteristic with respect to the incident angle of the on-axis light beam is optically disposed at a position closest to one of the different surfaces to be scanned.

Further, in the above-mentioned scanning optical apparatus, the different scanned surfaces include two surfaces to be scanned, the plurality of the mirrors disposed in each of two optical paths between the deflecting unit and the two surfaces to be scanned include two mirrors, of the two mirrors, in a direction along which each of the multiple light beams travels from the deflecting unit toward each of the two surfaces to be scanned, a mirror first changing one of the two optical paths is defined as a first mirror, and a mirror second changing the one of the two optical paths is defined as a second mirror, and when incident angles of the on-axis light beams on the respective first mirrors in the two optical paths in the sub-scanning section are Θ1a(°) and Θ1b(°), and incident angles of the on-axis light beams on the respective second mirrors in the two optical paths in the sub-scanning section are Θ2a(°) and Θ2b(°), the following conditions may be satisfied:

5(°)≦Θ1a(°)≦20(°);

5(°)≦Θ1b(°)≦20(°);

45(°)<|Θ2b(°)−Θ1b(°)|≦75(°); and

15(°)≦|Θ2a(°)−Θ1a(°)|≦45(°).

Alternatively, of the plural optical paths between the deflecting unit and the different surfaces to be scanned, an optical path having a smallest incident angle when the on-axis light beam is input to the mirror at the maximum incident angle of the on-axis light beam may be an optical path optically emitted onto one of the different surfaces to be scanned, which forms a color image having a lowest brightness among color images formed by the plural optical paths, respectively.

Further, in order to solve the above-mentioned problems, according to a further aspect of the present invention, there is provided an image forming apparatus including; the above-mentioned scanning optical apparatus, an image bearing member disposed on one of the different scanned surfaces, a developing unit which develops an electrostatic latent image formed on the image bearing member by a light beam scanned by the scanning optical apparatus as a toner image, a transferring unit which transfers the developed toner image to a transferred material, and a fixing unit which fixes the transferred toner image to the transferred material.

The above-mentioned image forming apparatus may further include a printer controller which converts code data input from an external device into image data, and inputs the image data to the scanning optical apparatus.

According the present invention, there can be obtained a scanning optical apparatus which is capable of forming a high quality image while the manufacture of the imaging optical system is facilitated, the length of the apparatus in the direction of height is reduced, and the unevenness of illuminance distribution (light amount distribution) on the surface to be scanned is reduced.

Further features of the present invention will become apparent from the following description of exemplary embodiments with reference to the attached drawings.

### BRIEF DESCRIPTION OF THE DRAWINGS

FIG. 1 is a schematic diagram illustrating a main portion of a main scanning section according to a first embodiment of the present invention.

FIG. 2 is a schematic diagram illustrating a main portion of a sub-scanning section according to the first embodiment of the present invention.

FIG. 3 is a schematic diagram illustrating a first mirror according to the first embodiment of the present invention.

FIGS. 4A and 4B are explanatory diagrams illustrating an image plane illuminance ratio according to the first embodiment of the present invention, respectively.

FIG. 5 is another schematic diagram illustrating the main portion of the sub-scanning section according to the first embodiment of the present invention.

FIGS. 6A and 6B are explanatory diagrams illustrating an image plane illuminance ratio according to a second embodiment of the present invention, respectively.

FIG. 7 is a schematic diagram illustrating a main portion of a sub-scanning section according to a third embodiment of the present invention.

FIGS. 8A and 8B are explanatory diagrams illustrating an image plane illuminance ratio according to the third embodiment of the present invention, respectively.

FIG. 9 is a schematic diagram illustrating a main portion of a sub-scanning section according to a fourth embodiment of the present invention.

FIGS. 10A and 10B are explanatory diagrams illustrating an image plane illuminance ratio according to the fourth embodiment of the present invention, respectively.

FIG. 11 is an explanatory diagram illustrating a BD sensor light receiving surface according to a fifth embodiment of the present invention.

FIG. 12 is a cross-sectional view illustrating a main portion of an embodiment of a color image forming apparatus to which the present invention can be applied.

FIG. 13 is a schematic diagram illustrating a sub-scanning section of a scanning optical apparatus in a conventional example.

### DESCRIPTION OF THE EMBODIMENTS

### First Embodiment

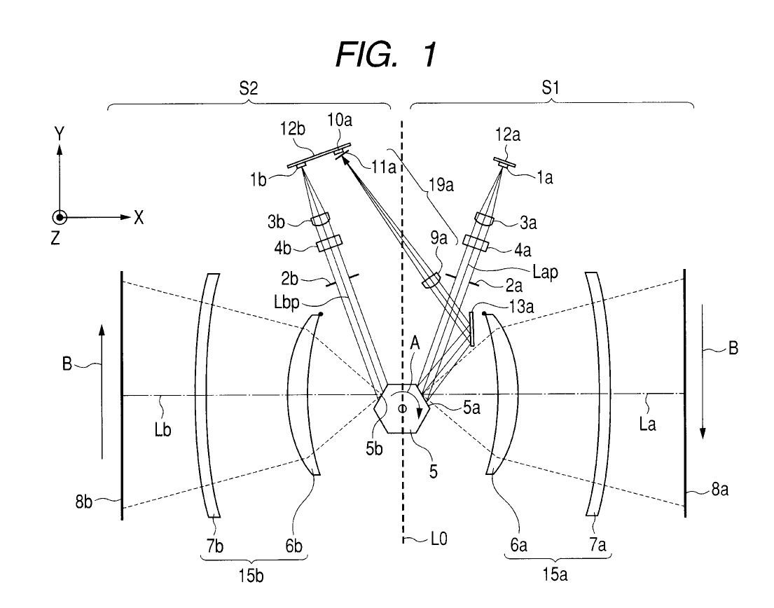

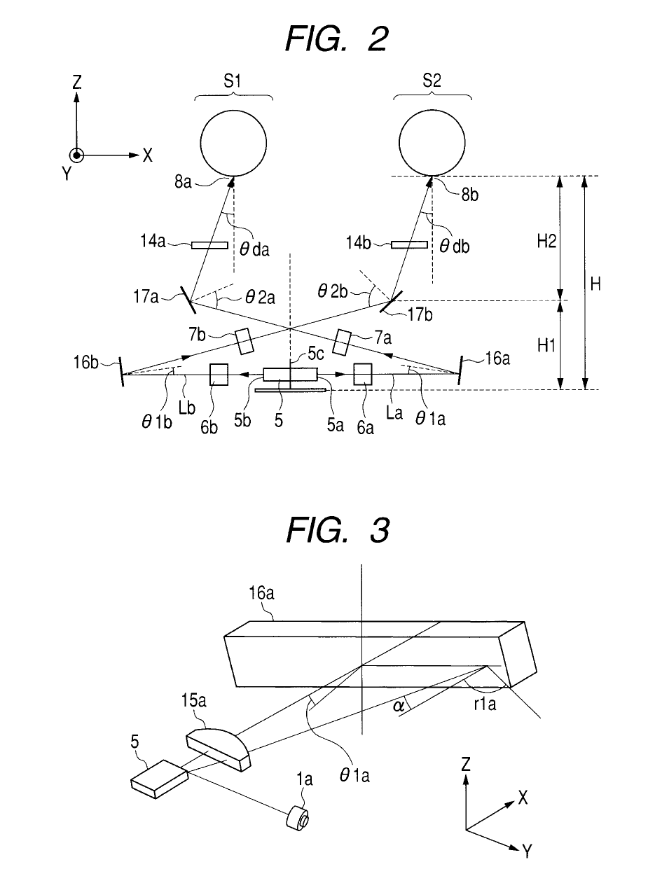

FIG. 1 is a cross-sectional view (main-scanning section view) illustrating a main portion of a scanning optical apparatus in a main-scanning direction according to a first embodiment of the present invention. FIG. 2 is a cross-sectional view (sub-scanning section view) illustrating a main portion of the scanning optical apparatus illustrated in FIG. 1 in a sub-scanning direction. In the following description, the main-scanning direction (Y-direction) is a direction (direction in which a light beam is deflected and reflected (deflected and scanned) by a deflecting unit) perpendicular to a rotation axis of the deflecting unit and an optical axis (X-direction) of an imaging optical system. The sub-scanning direction (Z-direction) is a direction parallel to the rotation axis of the deflecting unit. The main scanning section is a plane including the optical axis of the imaging optical system and the main-scanning direction. The sub-scanning section is a section including the optical axis of the imaging optical system and being perpendicular to the main-scanning section.

In the drawings, references S1 and S2 denote first and second scanning units (hereinafter referred to also as “station”), respectively.

In the respective members of the second scanning unit S2, the same members of those in the first scanning unit S1 are indicated with brackets.

The first (second) scanning unit S1 (S2) includes a light source unit 1a (1b) that emits a single or multiple light beams, and a first optical element 3a (3b) that changes a converging state of an incident light beam and outputs the light beam. Further, the first (second) scanning unit S1 (S2) includes a second optical element 4a (4b) having a refractive power only in the sub-scanning direction, an aperture stop 2a (2b) that limits a light beam width in the main-scanning direction, and an optical deflector (deflector) 5 as a deflecting unit.

Further, the first (second) scanning unit S1 (S2) includes an imaging optical system 15a (15b) that forms the light beams from the optical deflector 5 on a corresponding scanned surface 8a (8b) in the form of spots.

In this embodiment, the first and second scanning units S1 and S2 use the same optical deflector (deflecting unit) 5 together. Further, the first and second scanning units S1 and S2 use light beams reflected and deflected (deflected and scanned) by different deflection surfaces 5a and 5b of the optical deflector 5, respectively.

Further, the “light source portion” forming the light source unit 1a (1b) is configured to emit a light beam for optical scanning, and formed of a semiconductor laser, a light emitting diode, or the like.

The “first optical element” 3a (3b) couples the light beams from the light source unit 1a (1b) together, and converts the light beam emitted from the light source unit 1a (1b) into a “collimated light beam”, a “light beam having a low convergence property”, or a “light beam having a low divergence property” (hereinafter referred to as “collimator lens”).

The “second optical element” has a power for refracting the light beam coupled by the first optical element 3a (3b) only in the sub-scanning direction for converging the light beam on the deflection surface 5a (5b) of the optical deflector 5 in the form of a line longer in the main-scanning direction (hereinafter referred to as “cylindrical lens”).

The respective elements including the light source (1a and 1b), the collimator lens (3a and 3b), and the cylindrical lens (4a and 4b) configure one element of an incident optical system.

The optical deflector 5 is formed of, for example, a rotary polygon mirror having six facets, whose circumradius is 40 mm. The optical deflector 5 is rotated at a constant speed by a driving unit (not shown) such as a motor.

In this embodiment, the first and second scanning units S1 and S2 use the optical deflector 5 together, and the first and second scanning units S1 and S2 use the light beams reflected and deflected by the different deflection surfaces 5a and 5b of the optical deflector 5, respectively.

The scanning lens systems (imaging optical systems) 15a and 15b are each formed of two scanning lenses (imaging lenses) (6a, 7a, 6b, and 7b), and image the light beams reflected and deflected by the optical deflector 5 on the scanned surfaces 8a and 8b in the form of spots, respectively.

Further, the scanning lens systems 15a and 15b each have a field tilt correction function for the deflection surfaces 5a and 5b by provision of a conjugate relationship between the deflection surface of the optical deflector 5 or a vicinity thereof and the scanned surfaces 8a and 8b or vicinities thereof within the sub-scanning section.

The scanning lenses 6a, 7a, 6b, and 7b are each formed of a plastic lens having an aspherically shaped surface high in the degree of freedom in design.

In this embodiment, the configuration of the scanning lenses 6 and 7 located on the optical deflector 5 side is represented by a function of the following equations.

For example, it is assumed that a direction orthogonal to optical axes La and Lb within the main-scanning section on a scanning start side and a scanning end side with respect to the optical axes La and Lb of the scanning lenses 6 and 7 and the imaging optical systems 15a and 15b, which are located on the optical deflector 5 side is a Y-axis. Further, it is assumed that a direction orthogonal to the optical axes La and Lb within the sub-scanning section is a Z-axis. In this situation, a surface shape of the scanning lenses 6 and 7 on the scanning start side is represented by Equation 1.

$$x = \frac{\frac{{y}^{2}}{R}}{1 + \sqrt{\begin{matrix}1 - ( 1 + K ) \\ {( \frac{y}{R} )}^{2}\end{matrix}}} + {B}_{4 s} {y}^{4} + {B}_{6 s} {y}^{6} + {B}_{8 s} {y}^{8} + {B}_{10 s} {y}^{10} \qquad ( Equation 1 )$$

A surface shape thereof on the scanning end side is represented by Equation 2.

$$x = \frac{\frac{{y}^{2}}{R}}{1 + \sqrt{\begin{matrix}1 - ( 1 + K ) \\ {( \frac{y}{R} )}^{2}\end{matrix}}} + {B}_{4 e} {y}^{4} + {B}_{6 e} {y}^{6} + {B}_{8 e} {y}^{8} + {B}_{10 e} {y}^{10} \qquad ( Equation 2 )$$

where R is a radius of curvature, K, B₄, B₆, B₈, and B₁₀ are aspherical coefficients, suffix s of the coefficient is the scanning start side, and suffix e is the scanning end side.

Further, in the sub-scanning section, the curvature is continuously changed on both surfaces of the input surfaces and the output surfaces of the scanning lenses 6 and 7 within an effective portion of the scanning lens 7.

The output or emerged surface (R4 plane) of the scanning lens 7 is configured to be largest in refractive power (power: an inverse of a focal distance) among the lens surfaces forming the scanning lens systems 15a and 15b.

The configuration of the scanning lenses 6 and 7 within the sub-scanning section is represented by the following continuous function when it is assumed that the optical axis is an X-axis, a direction orthogonal to the optical axis within the main-scanning section is a Y-axis, and a direction orthogonal to the optical axis within the sub-scanning section is a Z-axis, on the scanning start side and the scanning end side with respect to the optical axis La.

A surface shape thereof on the scanning start side is represented by Equation 3.

$$S = \frac{\frac{{z}^{2}}{{r}^{′}}}{1 + \sqrt{1 - {( \frac{z}{{r}^{′}} )}^{2}}} \\ {r}^{′} = r ( 1 + {D}_{2 s} {y}^{2} + {D}_{4 s} {y}^{4} + {D}_{6 s} {y}^{6} + {D}_{8 s} {y}^{8} + {D}_{10 s} {y}^{10} ) \qquad ( Equation 3 )$$

A surface shape thereof on the scanning end side is represented by Equation 4.

$$S = \frac{\frac{{z}^{2}}{{r}^{′}}}{1 + \sqrt{1 - {( \frac{z}{{r}^{′}} )}^{2}}} \\ {r}^{′} = r ( 1 + {D}_{2 e} {y}^{2} + {D}_{4 e} {y}^{4} + {D}_{6 e} {y}^{6} + {D}_{8 e} {y}^{8} + {D}_{10 e} {y}^{10} ) \qquad ( Equation 4 )$$

where r′ is the radius of curvature in the sub-scanning direction, and D₂, D_{4 , D}₆, D₈, and D₁₀ are aspherical coefficients.

The radius of curvature in the sub-scanning direction is the radius of curvature in a section orthogonal to the configuration (meridian line) in the main-scanning direction.

Optical parameters in this embodiment are illustrated below.

TABLE 1

| | | |
|---|---|---|
| Wavelength, refractive index | | |
| Wavelength in use (nm) | λ | 790 |
| Refractive indexes of scanning lenses 6, 7 | Nd | 1.531 |
| Abbe number of scanning lenses 6, 7 | vd | 55.5 |
| BD lens refractive index | Nd | 1.492 |
| BD lens Abbe number | vd | 57.9 |
| Polygon | | |
| Number of planes | n | 6 |
| Circumradius (mm) | Φ | 40 |
| Light beam angle | | |
| Incident angle on optical deflector in main-scanning direction (°) | αm | 70 |
| Incident angle on optical deflector in sub-scanning direction (°) | αs | 0 |
| Maximum output angle from optical deflector in main-scanning | θ | ±39.4 |
| direction (°) | | |
| Synchronism detection angle (°) | θbd | 54 |
| Arrangement | | |
| Deflection surface - optical deflector side scanning lens first plane | d01 | 30 |
| (mm) | | |
| Optical deflector side scanning lens thickness (mm) | d12 | 7.5 |
| Optical deflector side scanning lens second plane - scanned | d23 | 91 |
| surface side scanning lens third plane (mm) | | |
| Scanned surface side scanning lens thickness (mm) | d34 | 5.5 |
| Scanned surface side scanning lens fourth plane - antidust glass | d45 | 66 |
| first plane (mm) | | |
| Antidust glass thickness (mm) | d56 | 1.8 |
| Antidust glass first plane - scanned surface (mm) | d67 | 64.7 |
| Scanning lens focal distance (mm) | fp | 200 |
| Collimator convergence degree | r0 | 1.00E+30 |
| Optical deflector - natural convergent point (mm) | | |

Optical deflector side scanning lens surface configuration

| | First plane | | Second plane | |
|---|---|---|---|---|
| | Scanning start | Scanning end | Scanning start | Scanning end side |
| | side (s) | side (e) | side (s) | (e) |
| R | −6.39E+01 | −6.39E+01 | −4.17E+01 | −4.17E+01 |
| K | −4.85E+00 | −4.85E+00 | −1.30E+00 | −1.30E+00 |
| B4 | 2.88996E−07 | 2.88996E−07 | 7.71306E−08 | 7.71306E−08 |
| B6 | −2.57796E−10 | −2.57796E−10 | 1.27316E−10 | 1.27316E−10 |
| B8 | −5.11634E−14 | −5.11634E−14 | −3.66856E−13 | −3.66856E−13 |
| B10 | 9.71935E−17 | 9.71935E−17 | 1.58269E−16 | 1.58269E−16 |
| r | −1.00E+03 | −1.00E+03 | −1.00E+03 | −1.00E+03 |
| D2 | 0 | 0 | 0 | 0 |
| D4 | 0 | 0 | 0 | 0 |
| D6 | 0 | 0 | 0 | 0 |
| D8 | 0 | 0 | 0 | 0 |
| D10 | 0 | 0 | 0 | 0 |

Scanned surface side scanning lens surface configuration

| | Third plane | | Fourth plane | |
|---|---|---|---|---|
| | Scanning start | Scanning end | Scanning start | Scanning end side |
| | side (s) | side (e) | side (s) | (e) |
| R | −1.16E+03 | −1.16E+03 | 1.58E+03 | 1.58E+03 |
| K | 0 | 0 | −1.38E+03 | −1.38E+03 |
| B4 | 0 | 0 | −1.65228E−07 | −1.65228E−07 |
| B6 | 0 | 0 | 1.1599E−11 | 1.1599E−11 |
| B8 | 0 | 0 | −6.81945E−16 | −6.81945E−16 |
| B10 | 0 | 0 | 1.79775E−20 | 1.79775E−20 |
| r | −1.00E+03 | −1.00E+03 | −3.33E+01 | −3.33E+01 |
| E2 | 0 | 0 | 4.77405E−05 | 0.000051174 |
| E4 | 0 | 0 | −6.41991E−09 | −7.53906E−09 |
| E6 | 0 | 0 | 6.47753E−13 | 1.02616E−12 |
| E8 | 0 | 0 | −3.27826E−17 | −9.21921E−17 |
| E10 | 0 | 0 | 5.14681E−22 | 3.81958E−21 |

Reference numeral 19a denotes a synchronization detecting unit of the first scanning unit S1 (hereinafter referred to also as “synchronization detecting optical system”).

The synchronization detecting optical system 19a includes a synchronization detecting optical element (hereinafter referred to also as “synchronization detecting lens”) 9a having a refractive power at least in the main-scanning direction, and a synchronization detecting element (hereinafter referred to also as “synchronization detecting sensor” or “BD sensor”) 10a.

Further, the synchronization detecting optical system 19a includes a slit (hereinafter referred to also as “synchronization detecting slit”) 11a arranged in front of the synchronization detecting sensor 10a. Further, the synchronization detecting optical system 19a includes an optical path changing unit (hereinafter referred to also as “synchronization detecting mirror”) 13a that guides a light beam out of an effective image area on the scanned surface 8a to the synchronization detecting sensor 10a.

On a circuit board 12b, the light source unit 1b and the synchronization detecting sensor 10a of the synchronization detecting optical system 19a are integrally fitted.

The synchronization detecting optical system 19a in this embodiment determines (controls) write (synchronization detecting) timing on the scanned surface 8a (8b) of the first or second scanning unit S1 (S2) according to a signal from the synchronization detecting sensor 10a.

In the synchronization detecting optical system 19a, the light beam for synchronization detecting (hereinafter referred to as “synchronization detecting light beam”) deflected and scanned by the deflection surface 5a is imaged on the synchronization detecting slit 11a surface. Then, the synchronization detecting light beam scans the synchronization detecting slit 11a within the main-scanning section with rotation of the optical deflector 5.

Further, a field tilt compensation system of the deflection surface 5a is configured on the sub-scanning section to provide a conjugate relationship between the deflection surface 5a and the synchronization detecting slit 11a.

The synchronization detecting slit 11a has an end shaped in a knife edge, and determines an image write position by taking timing of the light beam input onto the synchronization detecting sensor 10a. Further, the synchronization detecting light beam is imaged on the synchronization detecting slit 11a surface in both of the main-scanning direction and the sub-scanning direction.

For that reason, the diameter of a spot on the synchronization detecting sensor 10a surface is larger than the diameter on the synchronization detecting slit 11a surface. This configuration makes it difficult to generate the unevenness of sensitivity due to the manufacturing error of the synchronization detecting sensor 10a, and the unevenness of sensitivity due to deposits such as dusts.

In this embodiment, one synchronization detecting sensor 10a exists for two scanning units S1 and S2, and image write timing determined by the synchronization detecting sensor is used for both of the scanning units S1 and S2.

This embodiment illustrates a case in which write timing of the two scanning units S1 and S2 is determined by one synchronization detecting optical system 19a. However, the present invention is not limited to this embodiment, and the write timing of two scanning units S1 and S2 may be determined by two synchronization detecting optical systems, respectively.

That is, a configuration with the synchronization detecting optical system may be disposed for each of the scanning units S1 and S2, independently. With this configuration, the synchronization detecting timing (synchronization signal) is detected for each of the scanning units S1 and S2, independently, thereby enabling a relative error between the two scanning units S1 and S2 to be detected, and the write timing to be detected and controlled with higher precision.

Further, the two scanning units S1 and S2 are configured such that the light beams from the two light source units 1a and 1b are input to the optical deflector 5 from the same direction.

This embodiment illustrates a case of using two light source units 1a and 1b. However, the present invention is not limited to this configuration, and three or more light source units may be used.

Further, the principal rays Lap and Lbp of the light beam output from the light source units 1a and 1b are input to the optical deflector 5 at an angle of 70° with respect to the optical axes La and Lb of the imaging optical systems 15a and 15b.

The principal ray of the light beams means a beam that passes through the center of the aperture stop 2a (2b).

Then, description is given of the operation (optical action) of the scanning optical apparatus according to this embodiment.

In this embodiment, in the first (second) scanning unit S1 (S2), the light beam optically modulated and output from the light source unit 1a (1b) according to image information is converted into a collimated light beam, a light beam having a low convergence property, or a light beam having a low divergence property by means of the collimator lens 3a (3b). Then, the converted light beam is input to the cylindrical lens 4a (4b). The light beam within the main-scanning section, which has been input to the cylindrical lens 4a (4b), passes through the aperture stop 2a (2b) in an unchanged state.

On the other hand, the light beam within the sub-scanning section passes through the aperture stop 2a (2b) so as to be converged, and is imaged on the deflection surface 5a (5b) of the optical deflector 5 as a linear image (linear image longer in the main-scanning direction). Then, the light beam deflected and scanned by the deflection surface 5a (5b) of the optical deflector 5 is imaged on the photosensitive drum surface 8a (8b) in the form of spots by means of the imaging optical system 15a (15b).

Then, with rotation of the optical deflector 5 in a direction indicated by an arrow A, the light beam coming from the imaging optical system 15a (15b) optically scans the photosensitive drum surface 8a (8b) at a constant speed in a direction indicated by an arrow B (main-scanning direction). With the above-mentioned configuration, image recording is executed on the photosensitive drum 8a (8b) being a recording medium.

In this situation, the timing of the scanning start position on the photosensitive drum surface 8a (8b) is adjusted with the aid of the synchronization detecting signal 19a before optically scanning the photosensitive drum surface 8a (8b). To achieve that, a part of light beam deflected and scanned by the deflection surface 5a of the optical deflector 5 (synchronization detecting light beam) is turned back by the synchronization detecting mirror 13a, and guided to the synchronization detecting sensor 10a by means of the synchronization detecting lens 9a.

As the synchronization detecting light beam, there is used a light beam of a part out of the image formation light beam (out of the image formation area) on an “upstream side” with respect to the direction B along which the spot imaged on the scanned surface 8a (8b) scans, that is, the image write start side.

In this embodiment, the light beam emitted from the light source unit 1a of the first scanning unit S1 is reflected by the synchronization detecting mirror 13a. Then, the light beam is guided to the synchronization detecting sensor 10a located on the laser board 12b on which the light source unit 1b on the second scanning unit S2 side positioned at an opposite side of the optical deflector 5 is arranged.

The synchronization detecting sensor 10a in this embodiment is fitted integrally onto the laser board 12b together with the light source unit 1b as described above.

With the above-mentioned configuration, in this embodiment, the number of parts in the circuit board is reduced, the number of wirings to a control unit is more reduced, and the apparatus can be manufactured with a smaller area, thereby downsizing the entire apparatus. As an additional effect of the integral fitting of the synchronization detecting sensor 10a to the laser board 12b, the configuration is reduced in the number of connections of the wirings, and is hardly affected by the noises. Thus, there is an advantage in that the reliability is more enhanced.

Subsequently, the configuration of FIG. 2 is described.

FIG. 2 illustrates a sub-scanning section view in which two on-axis light beams La and Lb deflected and reflected by the two deflection surfaces 5a and 5b of the optical deflector 5 arrive at the corresponding scanned surfaces 8a and 8b, in the respective scanning units S1 and S2, respectively.

In the following description, the on-axis light beam is indicative of a beam when an angle formed between the principal ray of the light beam deflected and reflected by the deflection surfaces 5a and 5b of the optical deflector 5, and the optical axis La (Lb) of the imaging optical system 15a and 15b is 0°.

In this embodiment, two mirrors (optical path changing units) 16a and 17a (16b and 17b) are disposed in the optical path extending from the optical deflector 5 to the scanned surface 8a (8b).

In the following description, in the terms of a direction along the optical path arriving at the scanned surface 8a (8b) from the deflection surface 5a (5b) of the optical deflector 5, it is assumed that a mirror at which the light beam first arrives is a first mirror (first optical path changing unit) 16a (16b). A mirror at which the light beam second arrives is expressed as a second mirror (second optical path changing unit) 17a (17b).

In this embodiment, the light beams input to the optical deflector 5 through the cylindrical lenses 4a and 4b are set with a direction perpendicular to a rotating center axis 5c of the optical deflector 5 within the sub-scanning section. As a result, an angle formed between the light beam immediately after being deflected and reflected by the deflection surfaces 5a and 5b, and the rotating center axis 5c of the optical deflector 5 is also 90°.

In this situation, the incident angle (hereinafter referred to as “on-axis incident angle”) of the on-axis light beam La with respect to the respective mirrors is 7° in the on-axis incident angle Θ1a on the first mirror 16a and 42° in the on-axis incident angle Θ2a on the second mirror 17a in the scanning unit S1.

On the other hand, the on-axis incident angle Θ1b on the first mirror 16b is 7° and the on-axis incident angle Θ2b on the second mirror 17b is 62° in the scanning unit S2.

As described above, the on-axis incident angles of the second mirrors 17a and 17b in the scanning units S1 and S2 are made different from each other, thereby enabling a height H from a seating surface of the optical deflector 5 to the scanned surfaces 8a and 8b to be reduced.

In more detail, the on-axis incident angles Θ2a and Θ2b on the second mirrors 17a and 17b are made different from each other to reduce the height H.

0117 Further, at the same time, the directions of the light beams that have been turned back by the second mirrors 17a and 17b are uniformed between the scanning units S1 and S2. The following advantages are obtained by uniforming the directions of the light beams that have been turned back by the second mirrors 17a and 17b between the scanning units S1 and S2.

In the case of designing a color image forming apparatus for two or more colors on which a plurality of the scanning optical systems are mounted, when the respective image bearing members are arranged at regular intervals, and the angles at which the light beams are input to the scanned surfaces of the image bearing members are also made equal to each other, respectively, the degree of freedom of arrangement is large.

Further, in this embodiment, the light beams that have been reflected by the first mirrors 16a and 16b are in the direction of the rotation axis 5C of the optical deflector 5, and pass through an area (in space) above the deflection surfaces 5a and 5b, and cross each other. After that, the light beams arrive at the second mirrors 17a and 17b located above the opposed scanning lenses.

When the height H (refer to FIG. 2) is reduced by bringing the light beams input to the scanned surfaces 8a and 8b in nonparallel to the rotation axis 5c of the optical deflector 5 as in this embodiment, another arrangement other than this embodiment is proposed. The following is three typical examples.

A first example is configured such that the second mirrors 17a and 17b are not arranged on the scanning unit side of the opposed counter sides, but arranged in front of the optical deflector 5 so as not to pass through above of the optical deflector 5.

However, in this case, the distances between the first mirrors 16a and 16b and the second mirrors 17a and 17b are shortened with the result that the effect of reducing the height H is smaller, as compared with this embodiment.

Further, there is a disadvantage in that the second mirrors 17a and 17b and the scanning lenses 7a and 7b come close to each other, and the degree of freedom of arrangement is small.

A second example is a case in which the light beams that have been reflected by the first mirrors 16a and 16b are turned back in the seating surface direction of the optical deflector 5. In this case, because of the configuration of a housing configuring the seating surface of the optical deflector 5, it is difficult to allow the light beam to pass through the lower area of the optical deflector 5. For that reason, the light beams that have been turned back by the first mirrors 16a and 16b are turned back by the second mirrors 17a and 17b without crossing each other at the lower portion of the optical deflector 5.

Further, at that time, there are conceivable two options that the light beams are turned back upward by the second mirrors 17a and 17b, and the light beams are turned back downward. In the upward turnback, there is a disadvantage in that it is difficult to increase the angle Θ at which the light beams are nonparallel to the rotation axis 5c because of a problem with an interference of the light beams that have been reflected by the second mirrors 17a and 17b with the optical deflector 5.

On the other hand, in the downward turnback, the effect of reducing the height is small because of the same reason as that in the first example described above.

A third example is a configuration in which the first mirror is only used as the mirror. In this case, the light beam turned back by the first mirror is more deviated in the X-direction in FIG. 1 as the angle Θ(°) at which the light beam is nonparallel to the rotation axis 5c of the optical deflector 5 is larger.

Accordingly, it is difficult to downsize the scanning optical apparatus in view point of both of the height H and the width in the X-direction.

As compared with the above-mentioned three configuration examples, in the scanning optical apparatus according to this embodiment, it is easy to shorten both of the height H and the width in the X-direction.

Further, in the case of applying the configuration of this embodiment, for the purpose of further reducing the height H, it is desirable to satisfy the following two conditions. Next, this reason is described with reference to FIG. 2.

A first condition is that the first mirrors 16a and 16b turn back the light beams at an incident angle as small as possible in a range where the reflected light beam does not interfere with other members.

That is, when it is assumed that the incident angles of the on-axis light beams on the first mirrors 16a and 16b are Θ1a(°) and Θ1b(°), the following conditional expression (1) is satisfied.

5(°)≦Θ1a(°)≦20(°)

5(°)≦Θ1b(°)≦20(°) (1)

A lower limit in the conditional expression (1) is a condition where the reflected light beams do not interfere with other members, and an upper limit is an advantageous condition with the aim of reducing the height H1.

When the expression (1) is satisfied, a distance H1 between the first mirrors 16a and 16b and the second mirrors 17a and 17b in the Z-direction (direction of height of the scanning optical apparatus) can be reduced.

Further, a second condition is that the light beams turned back by the second mirrors 17a and 17b are guided to the scanned surfaces 8a and 8b in a direction nonparallel to the rotation axis 5c of the optical deflector 5 in the sub-scanning section.

That is, in the sub-scanning section, the angles 73 da(°) and Θdb(°) formed between the light beams that have been reflected by the second mirrors 17a and 17b, and the rotation axis 5c of the optical deflector 5 are set within a range of the following conditional expression (2).

0(°)<Θda(°)≦60(°)

0(°)<Θdb(°)≦60(°) (2)

The lower limit in the conditional expression (2) is a condition for performing the nonparallel arrangement, and the upper limit is a condition for preventing the width in the X-direction from excessively increasing.

In this example, when it is assumed that the incident angles of the on-axis light beam on the second mirrors 17a and 17b are Θ2a(°) and Θ2b(°), Θda and Θdb are obtained as follows (refer to FIG. 2).

Θda(°)=90(°)−(2×Θ2a(°)−2×Θ1a(°))

Θdb(°)=2×Θ2b(°)−2×Θ1b(°)−90(°) (3)

Further, the following conditional expression is established from Θda(°)=Θdb(°) and the expression (3).

(Θ2b(°)−Θ1b(°))+(Θ2a(°)−Θ1a(°))=90(°) (4)

Further, the following relational expression is established from the expressions (2) and (3).

45(°)<↑Θ2b(°)−Θ1b(°)|≦75(°)

15(°)<|Θ2a(°)−Θ1a(°)|≦45(°) (5)

Accordingly, the expression (5) being modified expression (2) is satisfied, thereby enabling a distance H2 between the second mirrors 17a and 17b and the scanned surfaces 8a and 8b in the Z-direction (direction of height of the scanning optical apparatus) to be reduced.

With satisfaction of the above-mentioned two conditions (conditional expressions (1) and (5)), it is easy to reduce the distance H in the Z-direction (direction of height of the scanning optical device) while preventing the width of the scanning optical apparatus in the X-direction from excessively increasing.

In this embodiment, the on-axis light beam incident angles Θ2a(°) and Θ2b(°) on the paired mirrors (second mirrors 17a and 17b) closest to the scanned surfaces in the opposed two optical paths are set to 42° and 62°, respectively. A difference |Θ2a(°)−Θ2b(°)| between the on-axis light beam incident angles on the second mirrors 17a and 17b is set to 20°.

Further, the angles Θda(°) and Θdb(°) formed between the light beams that have been reflected by the second mirrors 17a and 17b and the rotation axis 5c of the optical deflector 5 are set to 20°, respectively.

In this embodiment, the light beams from the light source units 1a and 1b are input to the deflection surfaces 5a and 5b with P deflection. Then, the light beams are input to the first mirrors 16a and 16b and the second mirrors 17a and 17b so that the direction of polarization of the laser beam becomes the linear polarization of an S polarization state for only the on-axis light beam of the imaging lenses 15a and 15b. Then, as the laser beams sequentially optically scan the scanned surfaces 8a and 8b from the on-axis of the imaging lenses 15a and 15b toward the off-axis by means of the optical deflector 5, the direction of polarization of the laser beam deviates more from the S-polarization to increase a ratio of the P-polarization component.

0146 FIG. 3 is an explanatory diagram illustrating the incident state of the laser beam on the first mirror 16a in the above-mentioned state. Because the same description can be applied to the remaining mirrors, only the first mirror 16a is shown in the following description.

In FIG. 3, a plane including an x-axis and a y-axis is illustrated as a main-scanning section. It is assumed that the scanning light beam travels from a point O toward a point A at an angle α(°) with the x-axis (the same direction as that of the on-axis light beam).

As illustrated in FIG. 3, an incident angle γ1a(°) on the first mirror 16a changes depending on a scanning field angle α(°), and the incident angle of the on-axis light beam on the first mirror 16a is expressed by the following expression using Θ1a(°).

γ1α[°]=cos⁻¹(cos α·cos θ1α)[°] (6)

0149 Further, when the on-axis light beam is input to the mirror with S polarization, the polarization direction of the off-axis light beam has a P-polarization intensity Ep² and an S-polarization intensity Es² at the following ratio.

$$\begin{matrix}{Ep}^{2} = \frac{{tan}^{2} α \cdot {( \frac{1}{tan θ 1 a} )}^{2}}{{tan}^{2} α + 1 + {tan}^{2} α \cdot {( \frac{1}{tan θ 1 a} )}^{2}} & ( 7 ) \\ {Es}^{2} = \frac{{tan}^{2} α + 1}{{tan}^{2} α + 1 + {tan}^{2} α \cdot {( \frac{1}{tan θ 1 a} )}^{2}} & ( 8 )\end{matrix}$$

Through the above-mentioned expressions (7) and (8), the P-polarization component continuously increases together with the field angle from on-axis toward off-axis. On the other hand, the S-polarization component continuously decreases from on-axis toward off-axis.

In this embodiment, with an aim to correct the unevenness of light amount distribution (the unevenness of image plane illuminance) on the scanned surface 8a, the components are set to continuously change according to the incident angle of the light beam on the mirror from on-axis toward off-axis, and the polarization direction.

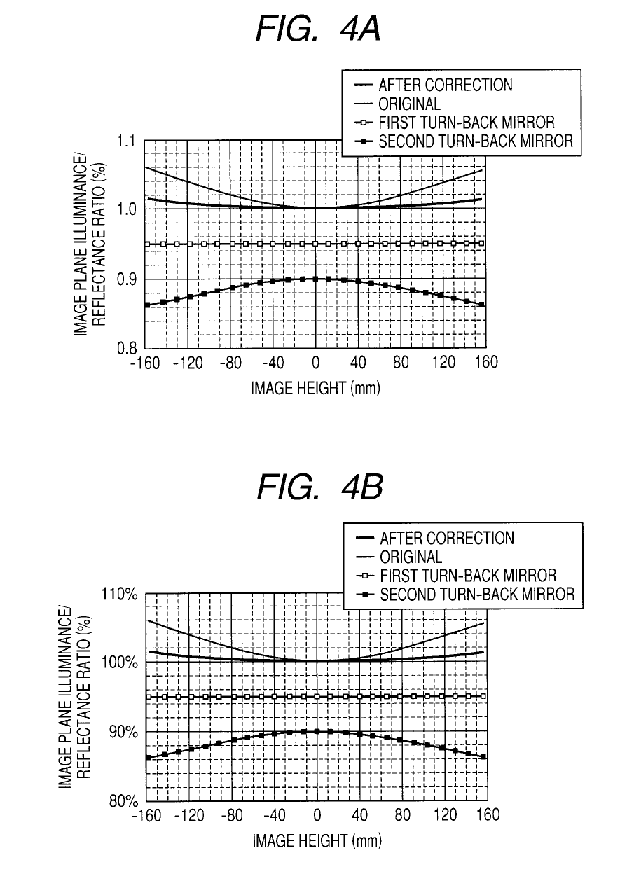

FIGS. 4A and 4B illustrate the unevenness of image plane illuminance (the unevenness of light amount distribution) on the scanned surface in this embodiment, FIG. 4A illustrates a correction effect on the scanning unit S1 side, and FIG. 4B illustrates a correction effect on the scanning unit S2 side. The light amount off the axis (image end portion) increases more than the light amount on the axis (image center) by 5% due to the imaging optical systems 15a and 15b, and the surface reflection (Fresnel reflection) of antidust glasses 14a and 14b (before correction).

The unevenness of image plane illuminance caused by the imaging optical systems 15a and 15b, and the antidust glasses 14a and 14b is corrected by continuously changing the incident angle of the deflected light beams on the mirrors, and the reflectance with respect to the polarization direction as described above.

In this embodiment, the first mirrors 16a and 16b have the common film characteristic. The reflectance of the on-axis light beam whose incident angle is 7° is set to 95%, and no difference in reflectance occurs between the on-axis light beam and the off-axis light beam. That is, the reflective films of the first mirrors 16a and 16b are optimized taking the angle of the incident light beam and the polarization direction into consideration such that the reflectance of the off-axis light beam whose incident angle is 33° is also 95%. In this case, Expression (1) is satisfied.

On the other hand, non-identical film characteristics are set to the second mirrors 17a and 17b. The use of the non-identical films enables to correct the unevenness of the image plane illuminance with the aid of the second mirrors 17a and 17b between which a difference in the on-axis incident angle occurs.

The reflectance characteristic with respect to the incident angle from the on-axis to the off-axis is different between the mirrors 17a and 17b different in the incident angle of the on-axis light beam, which are disposed in the respective optical paths in the same order from the optical deflector 5.

The second mirrors 17a and 17b are each set to 90% in reflectance of the on-axis light beam, and the reflective films of the second mirrors 17a and 17b are optimized taking the angle of the incident light beam and the polarization direction into consideration such that the reflectance of the off-axis light beam becomes lower than the reflectance of the on-axis light beam by 4%.

The reflectances of the on-axis light beams of the mirrors 17a and 17b different in the incident angle of the on-axis light beam, which are disposed in the respective optical paths in the same order from the optical deflector 5, are identical with each other. The incident angle of the on-axis light beam is defined as an angle formed by a normal line to each of the mirrors 17a and 17b and the principal ray of the light beam input to the mirror in the sub-scanning section.

That is, the second mirror 17a is configured to be 90% in the reflectance of the on-axis light beam whose incident angle is 42°, and 86% in the reflectance of the off-axis light beam whose incident angle is 49°. That is, the reflective film of the second mirror 17a is optimized taking the angle of the incident light beam and the polarization direction into consideration.

The second mirror 17b is configured to be 90% in the reflectance of the on-axis light beam whose incident angle is 62°, and 86% in the reflectance of the off-axis light beam whose incident angle is 66°. That is, the reflective film of the second mirror 17b is optimized taking the angle of the incident light beam and the polarization direction into consideration.

In this case,

Θ2b(°)−Θ1b(°)=62°−7°=55°, and

Θ2a(°)−Θ1a(°)=42°−7°=35°.

The expression (5) is satisfied.

With the above-mentioned setting, the unevenness of image plane illuminance is corrected to 1% (after correction).

In an attempt to provide the thin film characteristic different between the reflectance to the on-axis light beam and the reflectance to the off-axis light beam, the inventors of the present invention have found that the reduced reflectance of the mirrors (second mirrors 17a and 17b in this embodiment) is advantageous in manufacturing the film.

Under the circumstances, in this embodiment, the second mirrors 17a and 17b each have the reflectance different between on-axis and off-axis.

Further, the inventors of the present invention have found that the reflective film allowing the reflectance of the on-axis light beam and the reflectance of the off-axis light to easily differ from each other is equal to or lower than 90% in the reflectance of the on-axis light beam.

In the following description, a mirror that is equal to or lower than 90% in reflectance of the on-axis light beam is defined as a mirror small in the reflectance for descriptive purposes.

In this embodiment, only the imaging optical systems 15a and 15b, and the surface reflection (Fresnel reflection) components of the antidust glasses 14a and 14b are taken into consideration.

However, in actuality, there are the unevenness of image plane illuminance occurring due to the characteristic of the incident angle on the deflection surface 5a in the optical deflector 5 and a difference in diffraction efficiency of a diffraction optical element, and the unevenness of image plane illuminance due to internal absorption of the imaging optical systems 15a and 15b. Further, there is the unevenness of image plane illuminance occurring in using an overfield optical system (OFS), which can be also corrected.

The overfield optical system applied to the present invention is directed to an optical system in which the light beam is input in a state where the width of the light beam input to the deflection surface 5a in the main-scanning direction is larger than the width of the deflection surface 5a in the main-scanning direction.

In this embodiment, it is preferable that the image plane illuminance ratio on the scanned surface fall within ±4% in the effective scanning area on the basis of the on-axis image plane illuminance.

Further, in this embodiment, two mirrors are disposed in the optical path, but three or more mirrors may be disposed therein. Further, a reflective optical element (curved mirror) having a refractive power, such as a cylindrical mirror may be used in the optical path.

As described above, in this embodiment, the reflectance of the mirrors is continuously changed by the incident angle and the polarization direction. With this configuration, the unevenness of the image plane illuminance on the scanned surface is corrected, and a difference in the unevenness of the image plane illuminance can be more reduced among multiple scanning units. As a result, the scanning optical apparatus which obtains a high-definition image and is compact is achieved.

As illustrated in FIGS. 4A and 4B, in this embodiment, the image plane illuminance ratio on the scanned surface is corrected to fall within ±4% in the effective scanning area with respect to the on-axis image plane illuminance.

In this embodiment, when the scanning optical apparatus is used for the image forming apparatus forming two-color images, only one scanning optical apparatus may be used. When the scanning optical apparatus is used for a color image forming apparatus forming four-color images, an image may be formed by using two scanning optical apparatuses as described later.

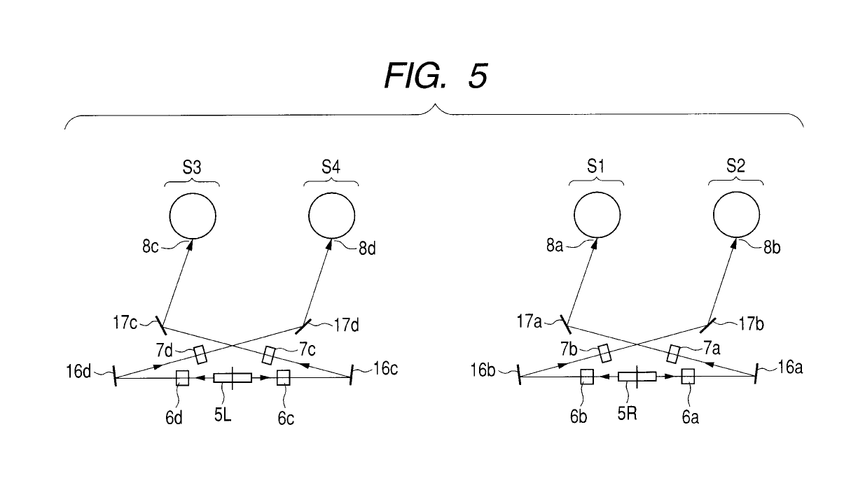

FIG. 5 is a schematic diagram illustrating the main portion of a color image forming apparatus according to the present invention. Two scanning optical apparatuses illustrated in FIG. 1 are arranged in parallel, and four scanning lines in total are drawn on the scanned surface by two reflectors 5L and 5R.

In FIG. 5, four light beams that have been reflected and deflected by the polygon mirror 5 (optical deflector) and passed through the first scanning lenses 6a, 6b, 6c, and 6d are input to the mirrors 16a, 16b, 16c, and 16d at an incident angle of 70.

After that, the light beams are input to the mirrors 17a and 17c at an incident angle of 420, and to the mirrors 17b and 17d at an incident angle of 620, through the scanning lenses 7a, 7b, 7c, and 7d. After that, the light beams are guided to the surfaces of the corresponding photosensitive drums 8a, 8b, 8c, and 8d.

Further, in this embodiment, as illustrated in FIG. 1, the cylindrical lenses 4a and 4b of the first and second scanning units S1 and S2 are disposed, independently. However, the present invention is not limited to this configuration, and, for example, the cylindrical lens may be integrally molded with a plastic mold. Further, in the first and second scanning units S1 and S2, the light beams from the light source units 1a and 1b may be guided directly to the optical deflector 5 through the aperture stops 2a and 2b without using the collimator lenses 3a and 3b, and the cylindrical lenses 4a and 4b.

Further, in this embodiment, the scanning lens systems 15a and 15b are each formed of two imaging lenses, but may be formed of one or three or more imaging lenses.

Further, in this embodiment, a case in which the number of deflection surfaces of the optical deflector 5 (polygon mirror) is six has been described. However, the present invention is not limited to the above-mentioned configuration, but the same effects can be obtained in the case where the number of deflection surfaces is three or more (for example, four, five, or seven).

In this embodiment, the rotating polygon mirror is used as the deflecting unit 5. Alternatively, there may be used a reciprocating (vibration) deflection element having mirror surfaces on both sides in which the deflection surface 5a reciprocates with the axis 5b as a rotation axis to reflect and deflect (deflect and scan) the light beam toward the scanned surfaces 8a and 8b.

Further, in this embodiment, two incident light beams are input to the deflection surfaces 5a and 5b not adjacent to each other, from the same direction. However, the present invention is not limited to this configuration, and the same effects can be obtained even when the incident directions are different, or when the light beams are input to the adjacent deflection surfaces.

Further, in this embodiment, the optical deflector 5 rotates clockwise. However, the present invention is not limited to this configuration, and the same effects can be obtained even with a counterclockwise rotation. Similarly, in this situation, it is preferable that a part of the BD light beam on the “upstream side” with respect to a direction B along which a spot imaged on the scanned surfaces 8a and 8b is scanned, that is, on the image write start side, which is out of the image formation light beam, be used as the BD light beam.

As described above, according to this embodiment, the above-mentioned configuration is advantageous to downsizing of the entire apparatus, the unevenness of light amount distribution on the image plane is small, and the high-grade image can be obtained.

### Second Embodiment

A scanning optical apparatus according to a second embodiment of the present invention is described. The main scanning section of the second embodiment is identical with the cross-sectional view of the main portion (main scanning cross-sectional view) of the scanning optical apparatus in the main-scanning direction in the first embodiment illustrated in FIG. 1. Further, the sub-scanning section is identical with the sub-scanning cross-sectional view in the first embodiment illustrated in FIG. 2.

In this embodiment, a difference from the above-mentioned first embodiment resides in that the first mirrors 16a and 16b, and the second mirror 17a are provided with the common thin-film characteristics. Other arrangements and numeric values related to the optical characteristics in this embodiment are identical with those in the first embodiment.

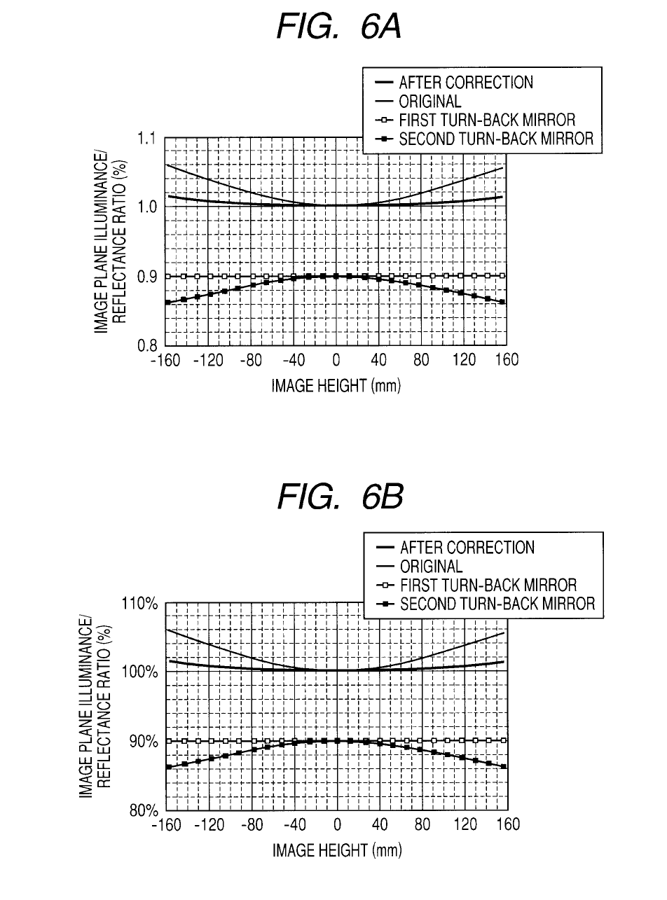

FIGS. 6A and 6B illustrate the unevenness of image plane illuminance on the scanned surface in this embodiment, FIG. 6A illustrates a correction effect on the scanning unit S1 side, and FIG. 6B illustrates a correction effect on the scanning unit S2 side. The light amount off the axis (image end portion) increases more than the light amount on the axis (image center) by 5% due to the imaging optical systems 15a and 15b, and the surface reflection (Fresnel reflection) of the antidust glasses 14a and 14b (before correction).

The unevenness of image plane illuminance caused by the imaging optical systems 15a and 15b, and the antidust glasses 14a and 14b is corrected by continuously changing the incident angle of the deflected light beams on the mirrors, and the reflectance with respect to the polarization direction as described above.

In this situation, in this embodiment, the first mirrors 16a and 16b among the first mirrors 16a and 16b, and the second mirror 17a having the common thin-film characteristic are 90% in the reflectance of the on-axis light beam whose incident angle is 7°.

Further, the reflective films of the first mirrors 16a and 16b are optimized taking the angle of the incident light beam and the polarization direction into consideration such that the reflectance of the off-axis light beam whose incident angle is 33° is also 90%.

In addition, the second mirror 17a is configured to be 90% in the reflectance of the on-axis light beam whose incident angle is 42°, and 86% in the reflectance of the off-axis light beam whose incident angle is 49°. That is, the reflective film of the second mirror 17a is optimized taking the angle of the incident light beam and the polarization direction into consideration.

As described above, a reflective film that satisfies both of two thin-film characteristics of the first mirrors 16a and 16b, and the second mirror 17a is commonly used for the mirrors 16a, 16b, and 17a, thereby facilitating the mirror manufacturing.

On the other hand, different film characteristics were set between the second mirrors 17a and 17b. The use of the different films enables the unevenness of image plane illuminance to be corrected by using the second mirrors which are different in the on-axis incident angle. The reflective film of the second mirror 17a is optimized taking the angle of the incident light beam and the polarization direction into consideration such that the second mirror 17a is 90% in the reflectance of the on-axis light beam whose incident angle is 42°, and 86% in the reflectance of the off-axis light beam whose incident angle is 49°.

The reflectance characteristic with respect to the incident angle from the on-axis to the off-axis is different between the mirrors 17a and 17b different in the incident angle of the on-axis light beam, which are disposed in the respective optical paths in the same order from the optical deflector 5.

With the above-mentioned configuration, the reflectance of the off-axis light beam is set to be lower than the reflectance of the on-axis light beam by 4%.

The reflective film of the second mirror 17b is optimized taking the angle of the incident light beam and the polarization direction into consideration such that the second mirror 17b is 90% in the reflectance of the on-axis light beam whose incident angle is 62°, and 86% in the reflectance of the off-axis light beam whose incident angle is 66°.

The reflectances of the on-axis light beams of the mirrors 17a and 17b different in the incident angle of the on-axis light beam, which are disposed in the respective optical paths in the same order from the optical deflector 5, are identical with each other. The incident angle of the on-axis light beam is defined as an angle formed by a normal line to each of the mirrors 17a and 17b and the principal ray of the light beam input to the mirror in the sub-scanning section.

With the above-mentioned configuration, the reflectance of the off-axis light beam is set to be lower than the reflectance of the on-axis light beam by 4%. As a result, the unevenness of image plane illuminance is corrected to 1% (after correction).

In this embodiment, only the imaging optical systems 15a and 15b, and the surface reflection (Fresnel reflection) components of the antidust glasses 14a and 14b are taken into consideration. However, in actuality, there are the unevenness of image plane illuminance occurring due to the characteristic of the incident angle on the deflection surface in the optical deflector and a difference in diffraction efficiency of a diffraction optical element, and the unevenness of image plane illuminance due to internal absorption of the imaging optical systems 15a and 15b. Further, there is the unevenness of image plane illuminance occurring in using an overfield optical system (OFS), which can be also corrected.

In the present invention, it is preferable that the image plane illuminance ratio on the scanned surface fall within ±4% in the effective scanning area on the basis of the on-axis image plane illuminance.

Further, in this embodiment, two mirrors are disposed in the optical path, but three or more mirrors may be disposed therein. Further, a reflective optical element (curved mirror) having a refractive power, such as a cylindrical mirror may be used.

As described above, in this embodiment, the reflectance of the mirrors is continuously changed by the incident angle and the polarization direction. With this configuration, the unevenness of the image plane illuminance on the scanned surface is corrected, and a difference in the unevenness of the image plane illuminance can be more reduced among multiple scanning units. As a result, the scanning optical apparatus which obtains a high-definition image and is compact is achieved.

As illustrated in FIGS. 6A and 6B, in this embodiment, the image plane illuminance ratio on the scanned surface is corrected to fall within ±4% in the effective scanning area with respect to the on-axis image plane illuminance.

In this embodiment, when the scanning optical apparatus is used for the image forming apparatus forming two-color images, only one scanning optical apparatus may be used. When the scanning optical apparatus is used for a color image forming apparatus forming four-color images, an image may be formed by using two scanning optical apparatuses as described later.

As described above, as an advantageous characteristic of this embodiment, the first mirrors 16a and 16b, and the second mirror 17a have the common thin-film characteristic, thereby further facilitating the manufacture compared with the first embodiment.

### Third Embodiment

A third embodiment of the present invention is described.

In this embodiment, a difference from the above-mentioned first embodiment resides in that a difference in the on-axis light beam incident angle between the two mirrors 17a and 17b closest to the scanned surface in the opposed two optical paths is further increased, and the height H is further reduced.

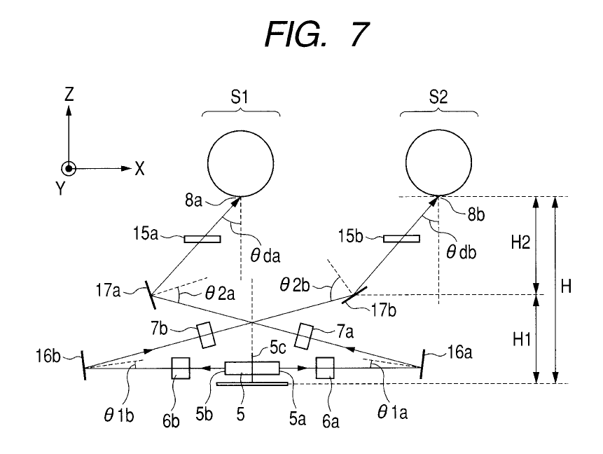

FIG. 7 is a diagram illustrating a sub-scanning section of a scanning optical apparatus according to a third embodiment of the present invention. Other arrangements and numeric values related to the optical characteristics in this embodiment are identical with those in the first embodiment.

In this embodiment, the on-axis light beam incident angles Θ2a(°) and Θ2b(°) of the two mirrors (second mirrors 17a and 17b) closest to the scanned surface in the opposed two optical paths are changed from those in the first embodiment.

As the real design values, the on-axis light beam incident angle Θ2a(°) of the second mirror 17a is 32°, and the on-axis light beam incident angle Θ2b(°) of the second mirror 17b is 68°. A difference |Θ2a(°)−Θ2b(°)| in the on-axis light beam incident angle between the second mirrors 17a and 17b was set to 36°.

Further, the angles Θda(°) and Θdb(°) formed by the light beams that have been reflected by the second mirrors 17a and 17b and the rotation axis 5c of the optical deflector 5 were set to 40°, respectively.

In this case,

Θ2b(°)−Θ1b(°)=68°−7°=61°, and

Θ2a(°)−Θ1a(°)=32°−7°=25°.

The expression (5) is satisfied. Further, the angles are further advantageous in downsizing as compared with those of the first embodiment.

In this embodiment, a distance H2 between the second mirrors 17a and 17b and the scanned surfaces 8a and 8b in the Z-direction (in the direction of height of the scanning optical apparatus) is reduced to 0.82 times (=cos 40°/cos 20°) as compared with the first embodiment.

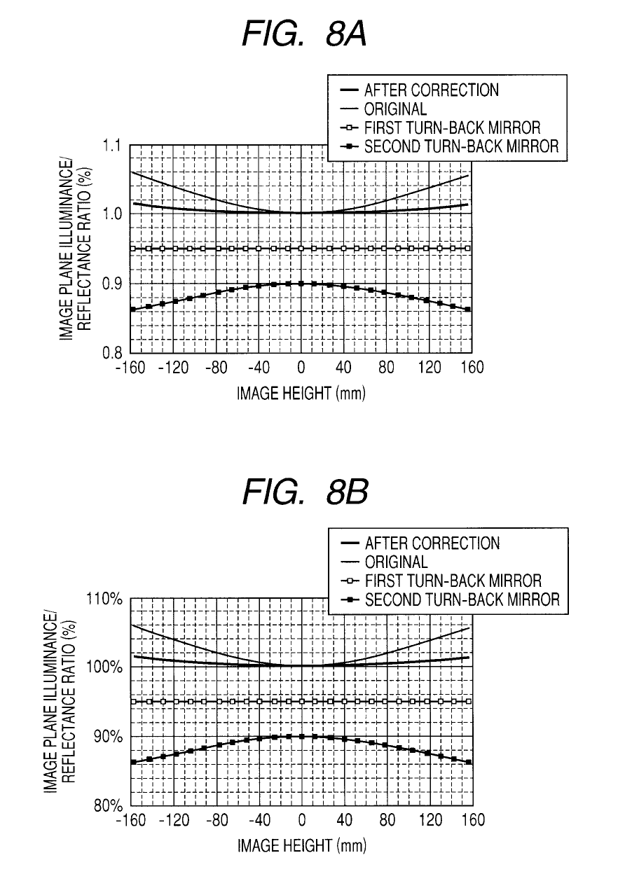

FIGS. 8A and 8B illustrate the unevenness of image plane illuminance on the scanned surface according to this embodiment, FIG. 8A illustrates the correction effect on the scanning unit S1 side, and FIG. 8B illustrates the correction effect on the scanning unit S2 side. The light amount off the axis (image end portion) increases more than the light amount on the axis (image center) by 5% due to the imaging optical systems 15a and 15b, and the surface reflection (Fresnel reflection) of the antidust glasses 14a and 14b (before correction).

The unevenness of the image plane illuminance occurring due to the imaging optical systems 15a and 15b, and the antidust glasses 14a and 14b is corrected by continuously changing the incident angle of the deflected light beam with respect to the mirrors and the reflectance with respect to the polarization direction as described above.

In this case, in this embodiment, the first mirrors 16a and 16b having the common thin-film characteristic are 95% in the reflectance of the on-axis light beam whose incident angle is 7°. Further, the reflective films of the first mirrors 16a and 16b are optimized taking the angle of the incident light beam and the polarization direction into consideration so that the reflectance of the off-axis light beam whose incident angle is 33° is also 95%.

On the other hand, the different film characteristics are set between the second mirrors 17a and 17b.

The use of the different films enables the unevenness of image plane illuminance to be corrected by using the second mirrors which are different in the on-axis incident angle. The reflective film of the second mirror 17a is optimized taking the angle of the incident light beam and the polarization direction into consideration so that the second mirror 17a is 90% in the reflectance of the on-axis light beam whose incident angle is 32°, and 86% in the reflectance of the off-axis light beam whose incident angle is 41°.

With the above-mentioned configuration, the reflectance of the off-axis light beam is set to be lower than that of the on-axis light beam by 4%. The reflective film of the second mirror 17b is optimized taking the angle of the incident light beam and the polarization direction into consideration so that the second mirror 17b is 90% in the reflectance of the on-axis light beam whose incident angle is 68°, and 86% in the reflectance of the off-axis light beam whose incident angle is 71°. With the above-mentioned configuration, the reflectance of the off-axis light beam is set to be lower than that of the on-axis light beam by 4%. As a result, the unevenness of image plane illuminance is corrected to 1% (after correction).

The reflectance characteristic with respect to the incident angle from the on-axis to the off-axis is different between the mirrors 17a and 17b different in the incident angle of the on-axis light beam, which are disposed in the respective optical paths in the same order from the optical deflector 5.

The reflectance of the on-axis light beam is identical between the mirrors 17a and 17b different in the incident angle of the on-axis light beam, which are disposed in the respective optical paths in the same order from the optical deflector 5. The incident angle of the on-axis light beam is defined as an angle formed by a normal line to each of the mirrors 17a and 17b and the principal ray of the light beam input to the mirror within the sub-scanning section.

As has been described above, the unique advantages of this embodiment reside in that a difference in the on-axis light beam incident angle between the two mirrors 17a and 17b closest to the scanned surface in the opposed two optical paths is further increased to further reduce the height H.

### Fourth Embodiment

A fourth embodiment of the present invention is described.

In this embodiment, a difference from the above-mentioned first embodiment resides in that the on-axis light beam incident angles of the two mirrors 17a and 17b closest to the deflector in the opposed two optical paths are further reduced to further reduce the height H.

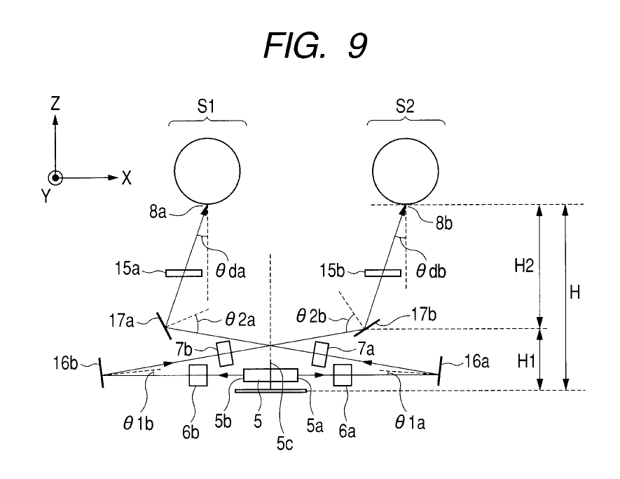

FIG. 9 is a diagram illustrating a sub-scanning section of a scanning optical apparatus according to a fourth embodiment of the present invention. Other arrangements and numeric values related to the optical characteristics in this embodiment are identical with those in the first embodiment.

The on-axis light beam incident angles Θ1a(°) and Θ1b(°) of the two mirrors (first mirrors 16a and 16b) closest to the deflector 5 in the opposed two optical paths are changed from those in the first embodiment.

As the real design values, the on-axis light beam incident angle Θ1a(°) of the first mirror 16a is 5°, and the on-axis light beam incident angle Θ1b(°) of the second mirror 16b is 5°.

In this case,

Θ2b(°)−Θ1b(°)=62°−5°=57°, and

Θ2a(°)−Θ1a(°)=42°−5°=37°.

The expression (5) is satisfied. Further, the angles are further advantageous in downsizing as compared with those in the first embodiment.

In this embodiment, the distance Hi between the first mirrors 16a and 16b and the second mirrors 17a and 17b in the Z-direction (in the direction of height of the scanning optical apparatus) is reduced to 0.72 times (=sin 10°/sin 14°) as compared with the first embodiment.

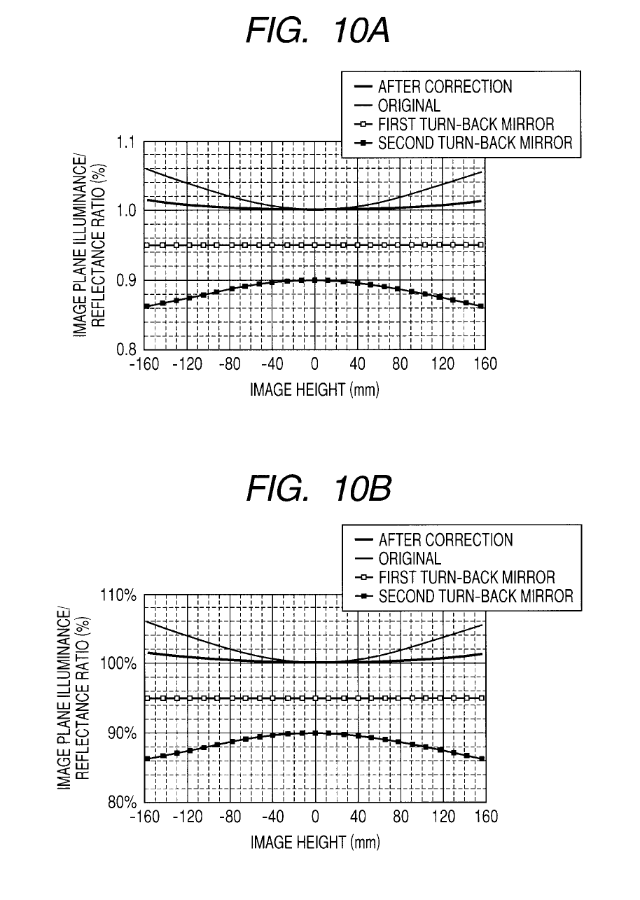

FIGS. 10A and 10B illustrate the unevenness of image plane illuminance on the scanned surface according to this embodiment. FIG. 10A illustrates the correction effect on the scanning unit S1 side, and FIG. 10B illustrates the correction effect on the scanning unit S2 side. The light amount of off-axis (image end portion) increases more than the light amount of on-axis (image center) by 5% due to the imaging optical systems 15a and 15b and the surface reflection (Fresnel reflection) of the antidust glasses 14a and 14b (before correction).

The unevenness of the image plane illuminance occurring due to the imaging optical systems 15a and 15b and the antidust glasses 14a and 14b is corrected by continuously changing the incident angle of the deflected light beam on the mirrors and the reflectance with respect to the polarization direction as described above.

In this case, in this embodiment, the first mirrors 16a and 16b having the common thin-film characteristic are 95% in the reflectance of the on-axis light beam whose incident angle is 5°. Further, the reflective films of the first mirrors 16a and 16b is optimized taking the angle of the incident light beam and the polarization direction into consideration so that the reflectance of the off-axis light beam whose incident angle is 32° is also 95%.

On the other hand, the different film characteristics are set between the second mirrors 17a and 17b. The use of the different films enables the unevenness of image plane illuminance to be corrected by using the second mirrors which are different in the on-axis incident angle. The reflective film of the second mirror 17a is optimized taking the angle of the incident light beam and the polarization direction into consideration so that the second mirror 17a is 90% in the reflectance of the on-axis light beam whose incident angle Θ2 is 42°, and 86% in the reflectance of the off-axis light beam whose incident angle is 49°. With the above-mentioned configuration, the reflectance of the off-axis light beam is set to be lower than that of the on-axis light beam by 4%.

The second mirror 17b is configured to be 90% in the reflectance of the on-axis light beam whose incident angle is 62°, and 86% in the reflectance of the off-axis light beam whose incident angle is 66°. That is, the reflective film of the second mirror 17b is optimized taking the angle of the incident light beam and the polarization direction into consideration. With the above-mentioned configuration, the reflectance of the off-axis light beam is set to be lower than that of the on-axis light beam by 4%. As a result, the unevenness of the image plane illuminance is corrected to 1% (after correction).

As has been described above, the unique advantages of this embodiment reside in that the on-axis light beam incident angles of the two mirrors 16a and 16b closest to the deflector are further reduced to further reduce the height H.

### Fifth Embodiment

Then, a fifth embodiment of the present invention is described.

In this embodiment, a difference from the above-mentioned first to fourth embodiments resides in that a BD sensor (synchronization detecting sensor) having two light receiving surfaces is used for the BD sensor to eliminate the BD slit (main scanning section view not shown).

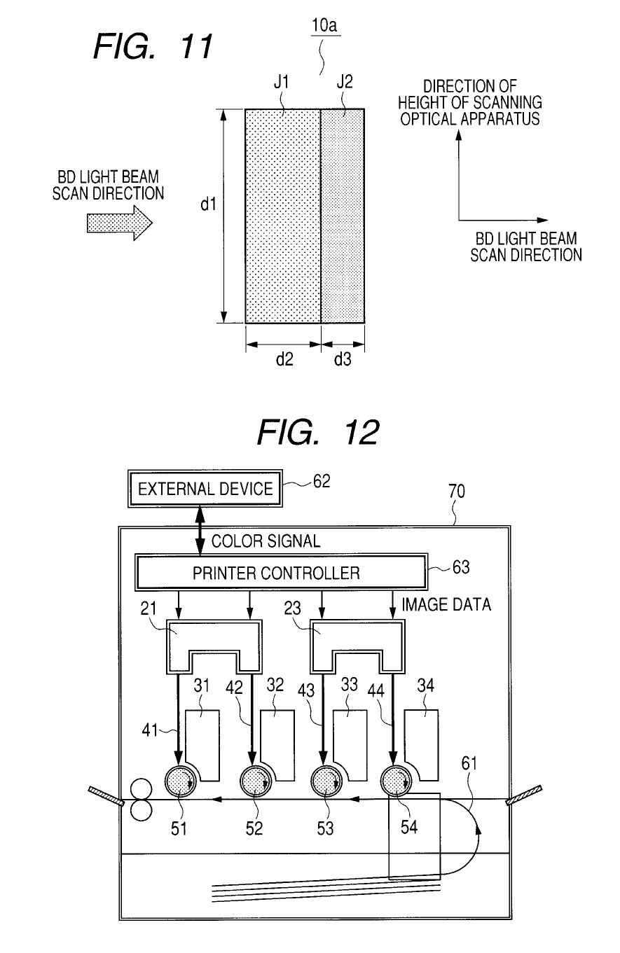

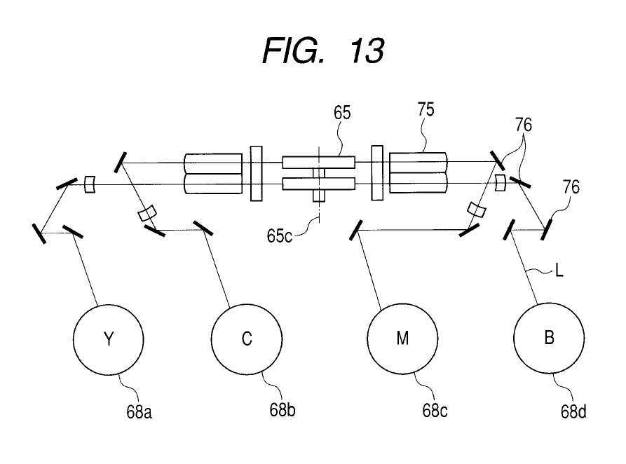

FIG. 11 is a schematic diagram illustrating the light receiving surface of a BD sensor 10a used in this embodiment.

The BD sensor 10a is formed of two light receiving surfaces J1 and J2, and the two light receiving surfaces J1 and J2 are aligned on the BD sensor 10a in a direction along which the BD light beam scans the BD sensor 10a.

A method of detecting synchronization detecting timing in the BD sensor 10a is described below.

For example, when the BD light beam scans the BD sensor 10a in a direction indicated by an arrow, the BD light beam first arrives at the light receiving surface J1, and thereafter arrives at the light receiving surface J2. Accordingly, when considering the light amount taken by both of the light receiving surfaces J1 and J2 in time series, there always exists one timing at which the light amounts taken by the light receiving surface J1 and the light receiving surface J2 are equal to each other.

In this embodiment, this timing is set as a synchronization detecting timing.

In this embodiment, the BD slit can be reduced to simplify the whole apparatus. Further, as compared with a case in which synchronization is detected with the aid of the BD slit, because the BD timing can be determined not depending on the scan speed of the BD light beam, the synchronization can be detected with higher precision.

In the above-mentioned first to fifth embodiments, the light source unit is made up of a single light emitting portion. However, the present invention is not limited to this configuration, and even if the light source unit is made up of a multi-beam semiconductor laser (multi-beam light source) having multiple light emitting portions, the present invention can be applied to the above-mentioned first to fifth embodiments, likewise. One of the advantages obtained by using the multi-beam light source resides in that the apparatus can deal with high speed and high definition printing without increasing the speed of the deflector, which may cause occurrence of noise and vibrations.

(Color Image Forming Apparatus)

FIG. 12 is a schematic diagram illustrating a main portion of a color image forming apparatus using the scanning optical apparatus according to any one of the first to fifth embodiments of the present invention.

This embodiment describes a tandem type color image forming apparatus in which two optical scanning apparatuses are arranged to record image information (electrostatic latent image) in parallel on photosensitive drums each serving as an image bearing member.

In FIG. 12, a color image forming apparatus 70 includes optical scanning apparatuses 21 and 23 each having the configuration described in any one of the first to fifth embodiments, photosensitive drums 51, 52, 53, and 54 each serving as an image bearing member, developing devices (developing units) 31, 32, 33, and 34, and a transport belt 61. In FIG. 12, the color image forming apparatus 70 also includes a transferring unit (not shown) that transfers a toner image developed by the developing unit onto a transferred material, and a fixing device (fixing unit) (not shown) that fixes the transferred toner image to the transferred material.

In FIG. 12, respective color signals (code data) of red (R), green (G), and blue (B) are input from an external device 62 such as a personal computer to the color image forming apparatus 70. The color signals are converted into pieces of image data of cyan (C), magenta (M), yellow (Y), and black (B) by a printer controller 63 in the color image forming apparatus. The pieces of image data are input to the optical scanning apparatuses 21 and 23.

Light beams 41, 42, 43, and 44 which are modulated according to the respective pieces of image data are emitted from the optical scanning apparatuses 21 and 22. Photosensitive drum surfaces of the photosensitive drums 51, 52, 53, and 54 are scanned with the light beams 41, 42, 43, and 44 in a main-scanning direction.

According to the color image forming apparatus to which this embodiment can be applied, the two optical scanning apparatuses 21 and 23 are arranged. The two optical scanning apparatuses respectively correspond to the respective colors of C (cyan), M (magenta), Y (yellow), and B (black). The image signals (image information) are recorded in parallel on the surfaces of the photosensitive drums 51, 52, 53, and 54, thereby printing a color image at high speed.

In this embodiment, color images of Y (yellow), M (magenta), C (cyan), and B (black) correspond to the scanning units S3, S4, S1, and S2 illustrated in FIG. 5 in the stated order. The scanning unit S3 including an optical path on a side of the second optical path changing unit, whose incident angle of the on-axis light beam is smaller, emits the light beam onto the scanned surface on which the color image Y (yellow) lowest in brightness among the color images formed by the respective light beams is formed.

The color image Y (yellow) lowest in brightness is used on the scanning unit S3 side on which an angle characteristic is hardly provided in view of the film manufacturing, thereby making the unevenness of concentration on the scanned surface invisible, and enabling a higher-grade image to be obtained.

According to the color image forming apparatus to which this embodiment can be applied, as described above, latent images of the respective colors are formed on the corresponding surfaces of the photosensitive drums 51, 52, 53, and 54 using the light beams based on the respective pieces of image data by each of the two scanning optical apparatuses 21 and 23. After that, the multi-transfer is performed on a recording material to produce a full color image.

A color image reading apparatus including a CCD sensor or the like may be used as the external device 62. In this case, the color image reading apparatus and the color image forming apparatus 70 constitute a color digital copying machine.

In the present invention, the scanning optical apparatus according to any one of the first to fifth embodiments is applied to the color image forming apparatus. It is needless to say that the scanning optical apparatus can be applied to a monochrome image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-234849, filed Sep. 12, 2008, which is hereby incorporated by reference herein in its entirety.

What is claimed is:

1. A scanning optical apparatus, comprising:
a plurality of light source units;
a deflecting unit which deflects and scans a plurality of light beams emitted from the plurality of light source units by different deflection surfaces of the deflecting unit;
an imaging optical system which is disposed corresponding to the plurality of light beams deflected and scanned by the different deflection surfaces of the deflecting unit, and images the plurality of light beams deflected and scanned by the different deflection surfaces of the deflecting unit on different surfaces to be scanned; and
the same number of mirrors which are disposed in each of plural optical paths between the deflecting unit and the different surfaces to be scanned, the mirrors disposed in each optical path including a mirror different in incident angle of an on-axis light beam in a sub-scanning section between the mirrors which are disposed in the respective optical paths in the same order from the deflecting unit,
wherein a reflectance of the on-axis light beam is same between the mirrors different in incident angle of the on-axis light beam, which are disposed in the respective optical paths in the same order from the deflecting unit, and
wherein the incident angle of the on-axis light beam is defined as an angle formed by a normal line to the mirror and a principal ray of a light beam input to the mirror in the sub-scanning section.

2. A scanning optical apparatus according to claim 1, wherein a plurality of the mirrors are disposed in each of the plural optical paths between the deflecting unit and the different surfaces to be scanned, and, of the plurality of the mirrors disposed in each of the plural optical paths, a mirror at a maximum incident angle of the on-axis light beam is a mirror different in reflectance with respect to the incident angle of the on-axis light beam.

3. A scanning optical apparatus according to claim 2, wherein the mirror at the maximum incident angle of the on-axis light beam is at an incident angle of 45 degrees or more in the sub-scanning section.

4. A scanning optical apparatus according to claim 2, wherein the plural optical paths between the deflecting unit and the different surfaces to be scanned cross each other in the sub-scanning section, and the mirror different in reflectance with respect to the incident angle of the on-axis light beam is optically disposed at a position closest to one of the different surfaces to be scanned.

5. A scanning optical apparatus according to claim 2,
wherein the different surfaces to be scanned consist two surfaces to be scanned,
wherein the plurality of the mirrors disposed in each of two optical paths between the deflecting unit and the two surfaces to be scanned consist two mirrors,
wherein, of the two mirrors, in a direction along which each of the plurality light beams travels from the deflecting unit toward each of the two surfaces to be scanned, a mirror first changing one of the two optical paths is defined as a first mirror, and a mirror second changing the one of the two optical paths is defined as a second mirror, and
wherein when incident angles of the on-axis light beams on the respective first mirrors in the two optical paths in the sub-scanning section are Θ1a(°) and Θ1b(°), and incident angles of the on-axis light beams on the respective second mirrors in the two optical paths in the sub-scanning section are Θ2a(°) and Θ2b(°), the following conditions are satisfied:
5(°)≦Θ1a(°)≦20(°);
5(°)≦Θ1b(°)≦20(°);
45(°)<|Θ2b(°)−Θ1b(°)|≦75(°); and
15(°)<|Θ2a(°)−Θ1a(°)|≦45(°).

6. A scanning optical apparatus according to claim 2,
wherein, of the plural optical paths between the deflecting unit and the different scanned surfaces, an optical path having a smallest incident angle when the on-axis light beam is input to the mirror at the maximum incident angle of the on-axis light beam is an optical path optically emitted onto one of the different surfaces to be scanned which forms a color image having a lowest brightness among color images formed by the multiple optical paths, respectively.

7. An image forming apparatus, comprising:
the scanning optical apparatus according to claim 1;
an image bearing member disposed on each of the different surfaces to be scanned;
a developing unit which develops an electrostatic latent image formed on the image bearing member by a light beam scanned by the scanning optical apparatus as a toner image;
a transferring unit which transfers the developed toner image to a transferred material; and
a fixing unit which fixes the transferred toner image to the transferred material.

8. An image forming apparatus according to claim 7, further comprising a printer controller which converts code data input from an external device into image data, and inputs the image data to the scanning optical apparatus.

9. A scanning optical apparatus, comprising:
a plurality of light source units;
a deflecting unit which deflects and scans a plurality of light beams emitted from the plurality of light source units by different deflection surfaces of the deflecting unit;
an imaging optical system which is disposed corresponding to the plurality of light beams deflected and scanned by the different deflection surfaces of the deflecting unit, and images the plurality of light beams deflected and scanned by the different deflection surfaces of the deflecting unit on different surfaces to be scanned; and
the same number of mirrors which are disposed in each of plural optical paths between the deflecting unit and the different surfaces to be scanned, the mirrors disposed in each optical path including a mirror different in incident angle of an on-axis light beam in a sub-scanning section between mirrors which are disposed in the respective optical paths in the same order from the deflecting unit,
wherein a reflectance characteristic with respect to the incident angle from on-axis to off-axis is different between the mirrors different in incident angle of the on-axis light beam, which are disposed in the respective optical paths in the same order from the deflecting unit, and
wherein the incident angle of the on-axis light beam is defined as an angle formed by a normal line to the mirror and a principal ray of a light beam input to the mirror in the sub-scanning section.

10. A scanning optical apparatus according to claim 9, wherein a plurality of the mirrors are disposed in each of the plural optical paths between the deflecting unit and the different surfaces to be scanned, and, of the plurality of the mirrors disposed in each of the plural optical paths, a mirror at a maximum incident angle of the on-axis light beam is a mirror different in reflectance characteristic with respect to the incident angle of the on-axis light beam.

11. A scanning optical apparatus according to claim 10, wherein the mirror at the maximum incident angle of the on-axis light beam is at an incident angle of 45 degrees or more in the sub-scanning section.

12. A scanning optical apparatus according to claim 10, wherein the plural optical paths between the deflecting unit and the different surfaces to be scanned cross each other in the sub-scanning section, and the mirror different in reflectance characteristic with respect to the incident angle of the on-axis light beam is optically disposed at a position closest to one of the different surfaces to be scanned.

13. A scanning optical apparatus according to claim 10,
wherein the different surfaces to be scanned consist two scanned surfaces,
wherein the plurality of the mirrors disposed in each of two optical paths between the deflecting unit and the two surfaces to be scanned consist two mirrors,
wherein, of the two mirrors, in a direction along which each of the plurality of light beams travels from the deflecting unit toward each of the two surfaces to be scanned, a mirror first changing one of the two optical paths is defined as a first mirror, and a mirror second changing the one of the two optical paths is defined as a second mirror, and
wherein when incident angles of the on-axis light beams on the respective first mirrors in the two optical paths in the sub-scanning section are Θ1a(°) and Θ1b(°), and incident angles of the on-axis light beams on the respective second mirrors in the two optical paths in the sub-scanning section are Θ2a(°) and Θ2b(°), the following conditions are satisfied:
5(°)≦Θ1a(°)≦20(°);
5(°)≦Θ1b(°)≦20(°);
45(°)<|Θ2b(°)−Θ1b(°)|≦75(°); and
15(°)<−Θ2a(°)−Θ1a(°)|≦45(°).

14. A scanning optical apparatus according to claim 10,
wherein, of the plural optical paths between the deflecting unit and the different surfaces to be scanned, an optical path having a smallest incident angle when the on-axis light beam is input to the mirror at the maximum incident angle of the on-axis light beam is an optical path optically emitted onto one of the different surfaces to be scanned which forms a color image having a lowest brightness among color images formed by the plural optical paths, respectively.

15. An image forming apparatus, comprising:
the scanning optical apparatus according to claim 9;
an image bearing member disposed on each of the different surfaces to be scanned;
a developing unit which develops an electrostatic latent image formed on the image bearing member by a light beam scanned by the scanning optical apparatus as a toner image;
a transferring unit which transfers the developed toner image to a transferred material; and
a fixing unit which fixes the transferred toner image to the transferred material.

16. An image forming apparatus according to claim 15, further comprising a printer controller which converts code data input from an external device into image data, and inputs the image data to the scanning optical apparatus.
